(19) United States
(12) Patent Application Publication
(10) Pub. No.: US 2016/0113840 A1
(43) Pub. Date: Apr. 28, 2016

(54) DIAGNOSTIC AND THERAPEUTIC TREATMENT DEVICE, AND RELATED SYSTEMS AND METHODS OF UTILIZING SUCH A DEVICE

(71) Applicant: SIGMA INSTRUMENTS HOLDINGS, LLC, Cranberry Twp, PA (US)

(72) Inventors: John CRUNICK, Cranberry Twp., PA (US); Tamas BECSE, Cranberry Twp., PA (US); Louis L. LASKEY, JR., Cranberry Twp., PA (US)

(73) Assignee: SIGMA INSTRUMENTS HOLDINGS, LLC, Cranberry Twp., PA (US)

(21) Appl. No.: 14/895,843

(22) PCT Filed: Jun. 4, 2014
(86) PCT No.: PCT/US2014/040953

§ 371 Date: Dec. 3, 2015

Related U.S. Application Data
(60) Provisional application No. 61/831,054, filed on Jun. 4, 2013.

(51) Int. Cl. A61H 23/00; A61H 23/02

(52) U.S. Cl. CPC A61H 23/006; A61H 23/0218; A61H 2201/5071; A61H 2201/0153; A61H 2201/5007

(57) ABSTRACT

A system for administering a therapeutic treatment to a portion of a patient body. In one embodiment the system includes a pressure sensor, a treatment head, and at least one computer processor in operable electrical communication with both the pressure sensor and treatment head. When a treatment tip of the treatment head is applied against the portion of the patient body, the at least one computer processor receives time dependent pressure readings from the pressure sensor corresponding to pressure applied by the treatment tip against the portion of the patient body. The at least one computer processor calculates a test frequency via an algorithm stored in the system. The system compares the test frequency to treatment plan frequencies and selects treatment plan based on the comparison.

### CROSS-REFERENCE TO RELATED APPLICATIONS

The present application claims priority under 35 U.S.C. §119 to U.S. Provisional Patent Application 61/831,054, which was filed Jun. 4, 2013, entitled “DIAGNOSTIC AND THERAPEUTIC TREATMENT DEVICE, AND RELATED SYSTEMS AND METHODS OF UTILIZING SUCH A DEVICE,” and is hereby incorporated by reference in its entirety into the present application.

### TECHNICAL FIELD

Aspects of the present invention involve a device for diagnostic and therapeutic treatment utilizing percussive impulse forces that utilizes a pressure sensing head to detect a characteristic surface pressure, calculate a corresponding treatment plan that includes a treatment frequency and power output, and deliver the treatment plan to the patient.

### BACKGROUND

Various mechanical and electromechanical devices are available for diagnostic and therapeutic treatment of a patient's joints, bones, muscles, and nerves. These devices span a wide range in both price and quality. Low quality devices often include poorly controlled vibration systems, arbitrary pulse frequencies, and single impulse delivery systems that offer few patient-specific treatment plans. Additionally, lower quality devices may only provide for a therapeutic treatment with little or no diagnostic functionality. Higher quality devices often attempt to provide for a patient-specific treatment and often contain both diagnostic and therapeutic functions. One such device may determine a frequency of a portion of a patient's body to undergo treatment (e.g., joint, muscle, spinal segment) in order to deliver a treatment plan that corresponds to the frequency of the specific portion of the patient's body. The device may include expensive sensing hardware (e.g., transducers) that is capable of both transmitting and receiving percussive impulse wave forms. A procedure for utilizing this type of device may include an initial test of the portion of a patient's body to undergo treatment by transmitting a wave form from a percussive impulse into the patient's body. The device may then detect a corresponding resultant wave form that is characteristic of the portion of the patient's body to undergo treatment. The resultant wave form can be analyzed to determine the natural, resonate, and/or fundamental frequency, among others. The frequencies can be used to develop a treatment plan to be used on the portion of the patient's body to undergo treatment. The device can be set to a frequency that corresponds to one of the characteristic frequencies of the patient's body and the device can be used to apply percussive impulse forces to the patient's body at such frequencies. While these devices may be effective in detecting a resulting wave form, the devices may require cumbersome processing systems (e.g., computer processor and display device) and expensive hardware (e.g., transducers). As such, there is a need in the art for devices and systems that determine treatment plans using alternative sensing equipment and methods. Additionally, there is a need in the art for hand held devices that include internal processing systems that provide for patient-specific treatment at a reasonable cost to consumers.

It is with these issues in mind that various aspects of the presently disclosed technology were developed.

### BRIEF SUMMARY

Aspects of the present disclosure involve a treatment device utilizing percussive impulse forces that generates patient-specific treatment plans. In certain embodiments, the device: detects a characteristic surface pressure of an area of a patient's body to undergo treatment by way of a pressure sensing head, calculates a correlating absorption rate based on the pressure readings using the device's data acquisition circuitry, converts the absorption rate to a frequency, compares and selects a preprogrammed treatment plan within the device's microcontroller that corresponds with the correlating frequency, and delivers percussive impulse forces according to the treatment plan.

In certain embodiments, the device includes a probe, an anvil firmly attached to the probe, an electromagnetic coil and an armature. The armature is inserted without attachment into the electromagnetic coil and configured so that when the coil is energized, the armature is accelerated to impact the anvil and thereby produce the force impulse which generates a wave form. A pressure sensor is attached to the device and is configured so that when the probe is pressed against a portion of a patient's body to undergo treatment it begins recording corresponding pressure values. The devices' data acquisition circuitry detects and stores the readings. When the pressure applied to the patient's body reaches a predetermined pressure value, or preload pressure, the device stops recording pressure values. In certain embodiments, the device includes a preloaded time constant, as opposed to a preloaded pressure value. The device then computes the absorption rate (i.e., curve defined by the function of change in pressure divided by change in time), which is converted to a frequency that corresponds with a fundamental frequency of the portion of the patient's body that is in contact with the tip of the probe. The device's data acquisition circuitry compares the value of computed frequency with frequency values of preloaded treatment plans. A plan is selected with a frequency value that most closely corresponds with the computed frequency. The treatment plan can include parameters such as frequency (i.e., frequency of the wave form), power output, pulse frequency (i.e., frequency of delivered wave forms, which are at the output frequency), time duration, number of pulses, etc. As an example, the device may be varied between approximately 0.1 and 12 hertz in increments of 0.1 hertz. After a plan is selected, the device employs the plan, wherein the treatment begins by producing percussive force impulses via the armature and anvil system according to the selected treatment plan. By repetitively accelerating the armature and impacting the anvil at controlled frequencies and controlled time periods, therapeutic results may be obtained.

Housed within the device is the data acquisition circuitry, which includes a microcontroller (e.g., PIC chip) that further includes a processor core, memory, and programmable I/O peripherals. Information relating to the force impulse, the pressure of the probe, the function for computing absorption rate and its conversion to frequency, the function for comparing the computed frequency to frequencies of the various treatment plans, and functions for executing the treatment plans are stored in the embedded code in the microprocessor.

The device can include a switch mechanism that coordinates between obtaining the preloaded pressure and the calculation of frequency, among other parameters. The switch mechanism is in a first position when the device is initially applied against the patient's body. The switch continues in the first position until the preloaded pressure value is obtained. At this point, data from pressure readings is used to compute a “loading curve” or hysteresis curve. This curve is used to determine the absorption rate, which is used, in turn, to determine a frequency of the portion of the patient's body that the probe tip is contacting. At this point, the switch is switched, manually or automatically, to a second position wherein the computed frequency is compared with frequencies of the various treatment plans. From this comparison, a treatment plan is selected that includes output frequency and/or a power setting, among other parameters.

Also disclosed herein is system for administering a therapeutic treatment to a portion of a patient body. In one embodiment the system includes a pressure sensor, a treatment head, and at least one computer processor in operable electrical communication with both the pressure sensor and treatment head. When a treatment tip of the treatment head is applied against the portion of the patient body, the at least one computer processor receives time dependent pressure readings from the pressure sensor corresponding to pressure applied by the treatment tip against the portion of the patient body. The at least one computer processor calculates from the time dependent pressure readings a test frequency via an algorithm stored in the system. The system compares the test frequency to treatment plan frequencies of stored treatment plans stored in the system and selects a selected treatment plan from the stored treatment plans based on the comparison. When the system is used to administer the therapeutic treatment to the portion of the patient body, the system causes the treatment head to operate according to the selected treatment plan.

Also disclosed herein is another system for administering a therapeutic treatment to a portion of a patient body. In one the system includes a microprocessor, a pressure sensor and a percussive impulse system. The microprocessor includes an input, an output and a memory. The input is configured to receive information associated with the therapeutic treatment. The output is configured to communicate information associated with the therapeutic treatment. The memory is in electrical communication with a CPU and includes treatment plans associated with the therapeutic treatment of the portion of the patient body and algorithms for comparing and selecting treatment plans. The CPU is in electrical communication with the input and the output. The pressure sensor is in electrical communication with the microprocessor and is configured to detect applied pressure and communicate time dependent pressure readings to the microprocessor. The percussive impulse system includes an armature, an anvil and a probe. The percussive impulse system is configured to provide oscillatory percussion therapy by way of the armature striking the anvil and delivering a force impulse wave that transmits through the anvil and into the probe, whereby the probe transfers the wave into the portion of the patient body when the probe is applied to the portion of the patient body during the administration of the therapeutic treatment. The system is configured to: i) calculate a test frequency via an algorithm based on the time dependent pressure readings, the algorithm being stored in the system; ii) compare the test frequency to treatment plan frequencies of the treatment plans stored on the system; iii) select a selected treatment plan by selecting one of the treatment plans based on the comparison between the test frequency and the treatment plan frequencies; and iv) apply the selected treatment plan via the percussive impulse system by performing the oscillatory percussion therapy according to a treatment plan frequency of the selected treatment plan.

Also disclosed herein is a system for therapeutic treatment of a portion of a patient body. In one embodiment the system includes a display device, at least one processing device in electrical communication with the display device, and a percussive impulse device electrically coupled with the at least one processing device. The at least one processing device includes an input, an output, a memory, and a CPU in electrical communication with the input, the output, and the memory. The memory includes software for operating a GUI displayed on a display device and configured to be interacted with by an operator. Treatment plan parameters are stored in the memory and displayed on the display device upon selecting via the GUI a first treatment plan or a second treatment plan, which are also stored in the memory. The treatment plan parameters for the first treatment plan include treatment locations corresponding to facial nerve exit points and the treatment plan parameters for the second treatment plan include treatment locations corresponding to facial muscle connection points. The percussive impulse device includes a pressure sensor and a probe. The percussive impulse device is configured to deliver force impulses with the probe to the portion of the patient body when the probe is applied to the portion of the patient body.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

Example embodiments are illustrated in referenced figures of the drawings. It is intended that the embodiments and figures disclosed herein are to be considered illustrative rather than limiting.

FIG. 1 is a cross-sectional side view of a percussive impulse device.

FIG. 2 is a schematic diagram showing the hardware components of the device used to determine a pre-load curve and deliver a wave form.

FIG. 3 is a schematic drawing of the system described herein.

FIGS. 4A and 4B are flowcharts outlining various methods disclosed herein.

FIGS. 5A-5D are loading curves depicted on pressure versus time graphs.

FIG. 6 is an embodiment of treatment plans to be implemented by the device.

FIG. 7 is a system for treating skin and underlying tissues for improved health and appearance.

FIGS. 8A-8B are treatment heads capable of generating microcurrent electrical neuromuscular stimulation.

FIG. 9 is an embodiment of a percussive impulse device utilizing a piezoelectric sensor.

FIG. 10 is a schematic diagram of a pressure wave generator.

FIG. 11 is a front view of a generic facial image of a patient with locations of trigeminal nerve exit points for treatment.

FIG. 12 is a front view of a generic facial image of a patient with locations of facial muscle connection points for treatment.

FIG. 13 is a front view of a generic facial image of a patient with location of points for ultrasonic treatment.

FIG. 14 is a screenshot of a graphical user interface that may be used with the system described herein.

### DETAILED DESCRIPTION

Implementations described and claimed herein address the foregoing problems by providing a treatment device and related systems and methods for determining characteristic frequencies (e.g., fundamental, resonate, natural) of a portion of a patient's body to undergo treatment by measuring pressure with a pressure sensing head, calculating a frequency that corresponds to the pressure readings, comparing and selecting a treatment plan based on the pressure readings, and performing the percussive impulse treatment according to treatment plan.

I. Percussive Impulse Device.

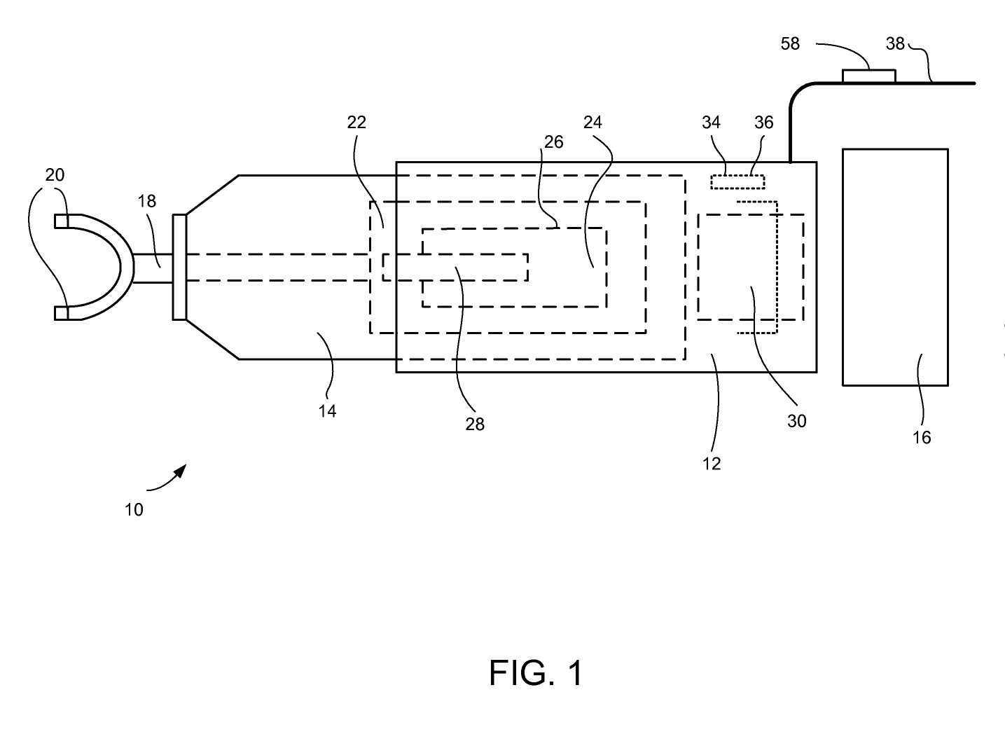

The treatment device or treatment head 10 described herein contains functional features of a diagnostic device 10 as well as a therapeutic device 10 in a portable and handheld unit. Referring to FIG. 1, the device 10 includes an elongated generally cylindrical housing 12 which has an insert 14 that tapers to form a generally conical configuration at one end. The other end of the housing 12 is provided with a cylindrical closed end 16. The housing 12 and the closed end 16 may be separately connected by a screw threaded connection to provide access into the interior of the housing 12 and to separate the components of the device for repair, replacement and the like. The housing 12 can be unscrewed or otherwise decoupled from the closed end 16, wherein it can slide back and the insert 14 can also be unscrewed or otherwise decoupled from the housing 12.

A treatment head or probe 18 is located at the forward end of the housing 12 and includes cushioned tips 20 for contacting a portion of the patient's body to undergo treatment. The probe 18 may be constructed of a rigid material such as metal, plastic, or the like. The probe screws into or frictionally inserts into the device 10. In one embodiment, the probe 18 couples with the anvil 22. Different shaped probes 18 may be used for different treatment plans. Differences may include the spacing between the tips 20 as well as the relative angle between the two tips 20. Additionally, the probe 18 may include a single tip 20 or any number of tips 20 suitable for a particular treatment plan.

Within the housing 12 is a solenoid assembly 24. The assembly 24 includes an electromagnetic coil 26 and an armature 28 longitudinally reciprocally mounted without attachment within the coil 26. The armature 28 is configured so that the end of the armature 28 will impact against the anvil 22 when the electromagnetic coil 26 is energized. The impact produces a force impulse which travels through the anvil 22, which generates a wave form that travels into the probe 18 and then through the tip and into the patient. When a probe 18 is placed against a patient's skin, the other end of the probe 18 resides firmly against the anvil 22.

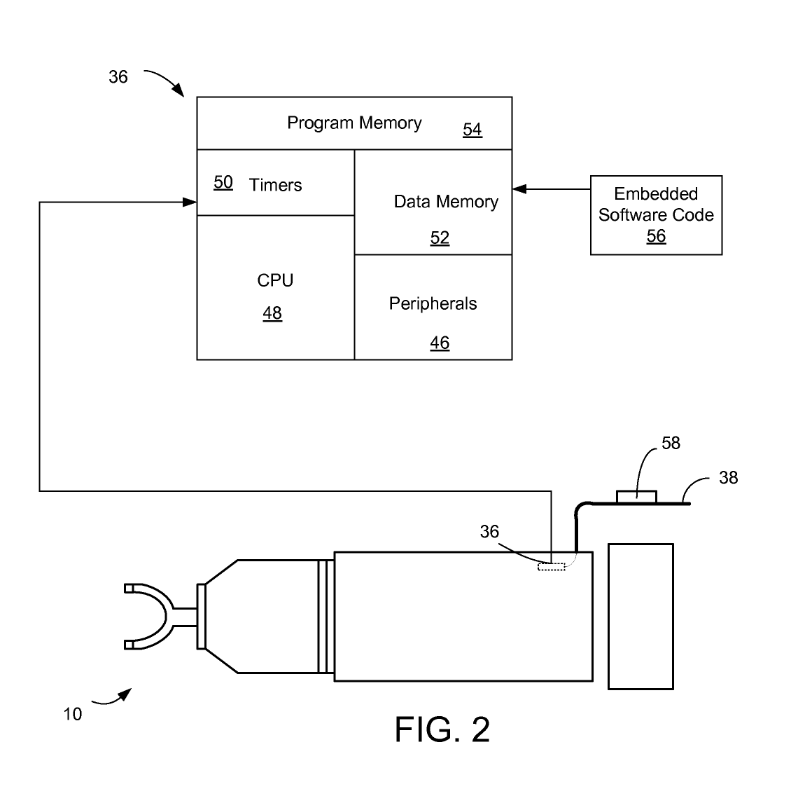

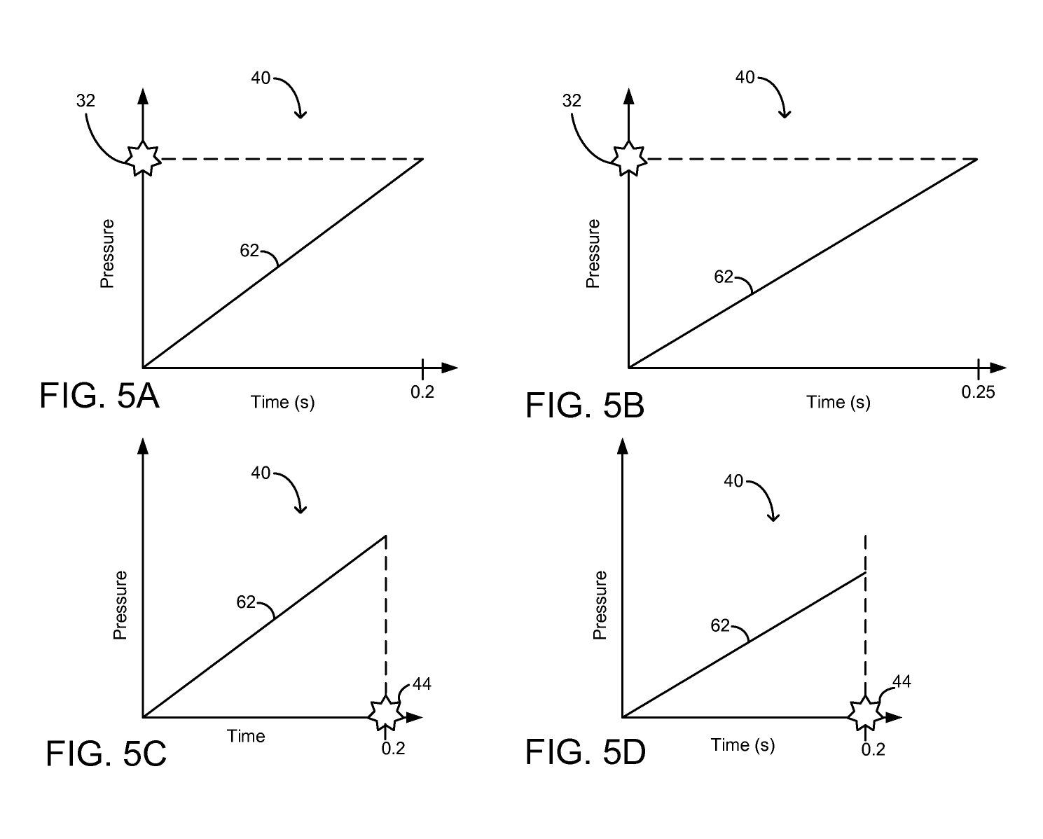

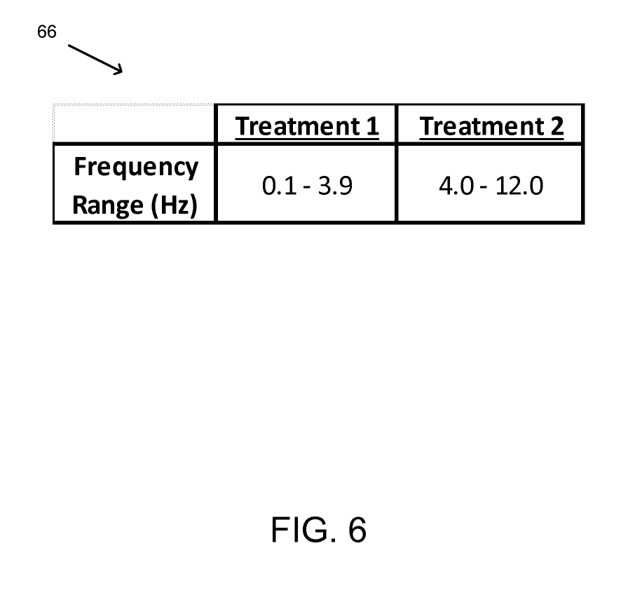

A pressure sensor 30 resides in the housing 12 and is interposed between the closed end 16 of the housing 12 and the solenoid 24. The pressure sensor 30 is communicably coupled to a data acquisition system 34, which further includes a microprocessor 36. As depicted in FIG. 2, the microprocessor 36 comprises program memory 54, timers 50, a central processing unit (CPU) 48 for running programs 56, data memory 52, and an input/output for controlling peripheral devices 46. The microprocessor 36 includes algorithms for running a preload sequence 40 (seen in FIGS. 5A-5D), taking time dependent pressure readings, analyzing data, and comparing data to preprogrammed treatment plans 66 (seen in FIG. 6), among other functions.

Still referring to FIG. 2, the device 10 further includes a power supply 58 in electrical communication with the microprocessor 36 and the electromagnetic coil 26. The power supply 58 is electrically coupled to a power chord 38 that connects that device 10 to a suitable electrical outlet, which supplies the device 10 with power. The pressure sensor 30 works in concert with each of the other components of the device 10 by communicating pressure readings to the microprocessor 36. In addition to FIG. 2 and as can be seen in FIGS. 5A-5D, which will be discussed in further detail at a later point, upon reaching a point that corresponds to a predetermined loading pressure 32 (seen in FIGS. 5A-5B) against the patient's skin, the microprocessor 36 signals the power supply 58 to release a burst of current that energizes the electromagnetic coil 26 such that the armature 28 is accelerated to impact the anvil 22. Referring back to FIGS. 1-2, the pressure sensor 30 may be comprised of a load cell. The pressure sensor 30 can be any instrument capable of reading pressure either directly or indirectly (e.g., pressure gauge, proximity sensor). The impact of said armature 28 against the anvil 22 produces a force impulse which travels directionally, in a continuum with the direction of the armature 28 at impact while at the same time being influenced by the resistance placed upon the anvil 22 by the probe 18 which is in contact with the patient. The kinetic energy at the point of impact causes the anvil to emit a shockwave which is characteristic of all of the elements of the electromechanical system on one side of the anvil opposed by all of the human elements on the other side of the anvil.

The mass of the armature 28 is substantially equal to the mass of the anvil 22 so that when the armature 28 strikes the anvil 22 it transfers the energy of the armature 28 to the patient through the cushioned probe 18. The initial positions of the coil 26 and the probe 18 are fixed so that the energy of the system can only be varied by varying velocity of the armature 28 at the point of impact with the anvil 22. The velocity of the armature 28 can be varied by varying the force with which it is accelerated into the electromagnetic coil 24. The force is proportional to the current flowing into the coils 26 of the solenoid 24 which in turn is proportional to the voltage. The triggering point at which the solenoid 24 is actuated can be varied by the relative movement pressure of the housing 12 inwardly in relation to the solenoid 24 and the probe 18 so that when the predetermined load pressure has been met, the microprocessor 36 signals the power supply 58 to fire a burst of electric current to the electromagnetic coil 26.

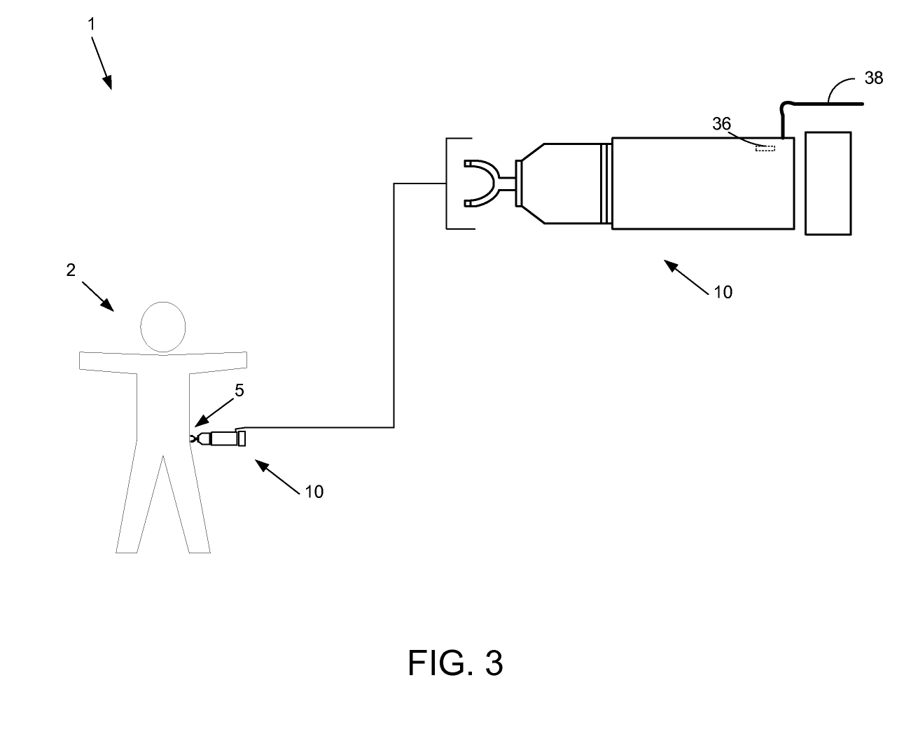

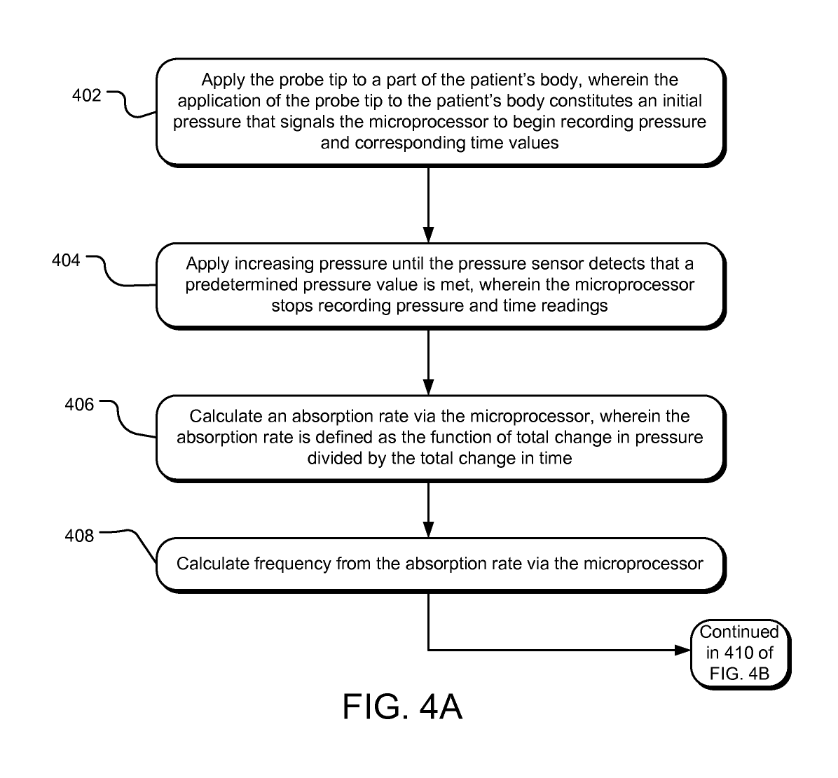

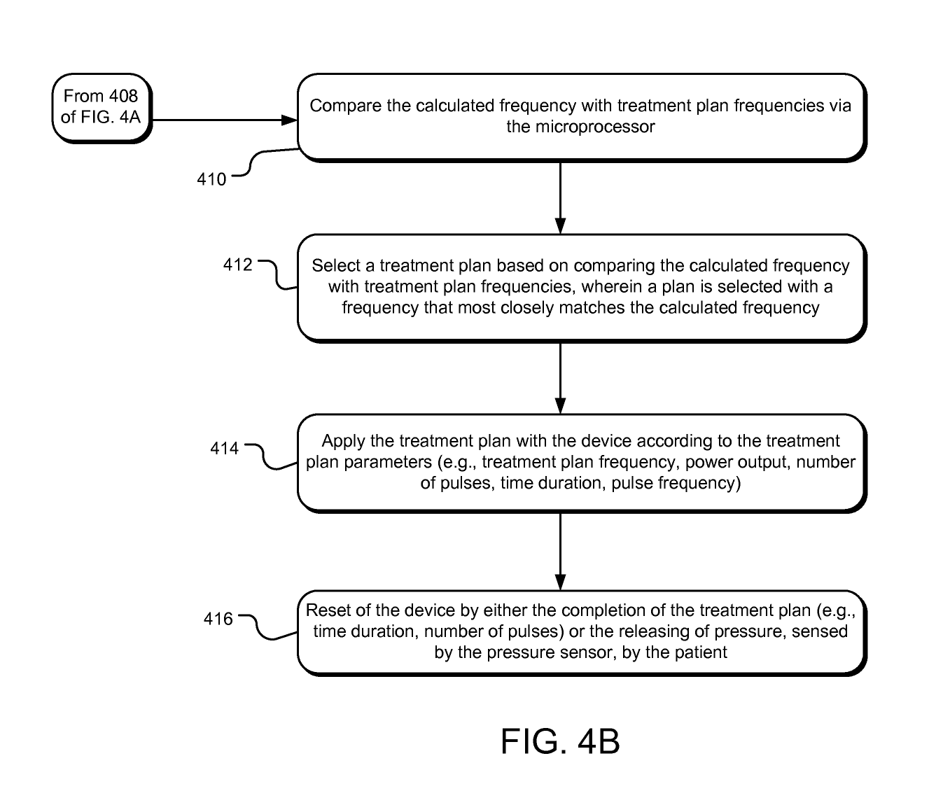

For an overview discussion of the systems and methods of utilizing the device 10, reference is made to FIGS. 1-4B. FIG. 1 is a cross-sectional view of the device 10 that depicts the internal components. FIG. 2 is a schematic diagram of the hardware components of the device 10 that run the internal processing for the methods disclosed herein. FIG. 3 depicts a system 1 employing the device 10 on a patient 5. FIGS. 4A-4B are flow chart diagrams outlining the system and method disclosed herein. The following overview discussion can be broken down into three sections.

The first section, which is discussed with respect to FIGS. 1, 2, and 4A, pertains to the device 10 and an example method of gathering data relating to an area of a patient's body to undergo treatment with the pressure sensor. The second section, which is discussed with respect to FIGS. 1, 2 and 4A-4B, pertains to an example method of analyzing the data relating to the patient's body in order to select a treatment plan that corresponds with characteristics of the analyzed portion of the patient's body. The third section, which is discussed with respect to FIGS. 1, 2, and 4B, pertains to an example method of application of the patient specific treatment plan to the patient's body.

A. Data Gathering Via the Pressure Sensor and the Data Acquisition System.

Referring to FIG. 4A for the following discussion, the device 10 is used by a patient for diagnostic as well as therapeutic treatment. In a certain embodiment, the device 10 functions initially as a diagnostic tool to determine characteristic frequencies (e.g., fundamental, natural, resonate) associated with the portion of the patient's body 5 that is in contact with the probe 18.

First, as indicated in FIG. 3, the patient 2 determines a part of the body 5 to treat. Such a body part 5 can be a trigger point of a muscle, nerve, joint, etc. The patient 2 ensures that the device 10 is plugged into a power outlet via the electric chord 38. The patient 2 places the probe 18 tip 20 to the portion of the body 5 to undergo treatment and the patient 2 begins applying pressure [block 402]. The pressure sensor 30 detects the initial pressure, which triggers the device 10 to begin gathering data related to the amount of pressure at corresponding time values [block 402]. The data can include additional factors related to the application of the device as needed. Alternatively, the device 10 can include an on/off switch, wherein the device 10 can begin taking data measurements when the device 10 is turned on. The pressure and time values can be gathered in fractions of a second (e.g., milliseconds) in order to obtain a sufficient number of data points to produce a suitable loading or pressure curve.

As can be understood from FIGS. 1-3, the pressure sensor 30 detects pressure corresponding to the patient's 2 application of the device 10 to the skin 5 and the data associated with the pressure is read by the data acquisition system 34, which stores the data in the memory of the microprocessor 36. Data is continually gathered until a predetermined pressure value 32 (e.g., two lbf) is obtained [block 404]. This pressure value 32 (shown in FIGS. 5A-5B) can be preset in the device 10 or the user can specify such a value.

In a certain embodiment, the preloaded pressure value 32 signals the device 10 to stop recording data and begin analyzing the data [block 404]. The time between the initial pressure reading and the time when the predetermined pressure value 32 is reached is used in computing various factors, such as an absorption rate [block 406]. Additionally, the corresponding pressure values for each time increment is used in computing various factors as well. In a certain embodiment, the time between the initial reading and the predetermined pressure value 32 being met may only be a few seconds. The exact amount of time will depend on the relative speed and amount of pressure applied by a user 2. For example, a patient 2 may rapidly apply the probe 18 to the skin 5 with sufficient force so that the preloaded pressure value 32 is sensed rather quickly. In another example, a patient may apply a small initial force and slowly increase the applied force until the preloaded pressure value 32 is sensed. In both examples, the patient 2 is not burdened by a lengthy and cumbersome diagnostic phase of the treatment.

B. Analyzing the Gathered Data and Selection of a Treatment Plan.

Once the pressure sensor detects that the preloaded pressure value 32 is met, as can be understood from FIGS. 5A-5B, the data acquisition system 34, shown in FIG. 1, analyzes the data. Since the pressure sensor 30 takes pressure readings over time, the data points corresponding to each discrete measurement of pressure and time can be plotted on a graph (e.g., pressure (y-axis) versus time (x-axis) graph) to create a pressure or loading curve 62, as illustrated in FIGS. 5A-5D. The profile of the loading curve 62 can predict certain characteristics related to the body part 5 of the patient 2 to determine whether the analyzed body part 5 was soft tissue, rigid bone, tough muscle, etc. Because different portions of a human body exhibit different levels of hardness and softness, pressure curves corresponding to the different areas of the body will exhibit differing curves. For example, a harder surface (e.g., bone, tendon) will exhibit a steeper more linear curve, whereas a pressure curve 62 corresponding to a softer surface (e.g., fatty tissue in the abdomen) will exhibit a more gradual, sloped curve or, simply, a curve with a lower rise/run value. While points corresponding to pressure and time are described herein as being plotted on a graph and represented in a curve, such a step may not be required by the microprocessor 36 when computing the absorption rate and/or frequency.

As indicated in FIGS. 4A and 5A-5D, from the loading curve 62, an absorption rate is calculated [block 406]. In a certain embodiment, the absorption rate is a function of the total change in pressure, divided by the total change in time (absorption rate=ΔPressure/ΔTime), wherein the limits are defined between the initial pressure reading being time zero and the preload pressure value being the ending time.

Reference is now made to FIGS. 5A-5D, which are graphs of pressure versus time of various preload sequences 40. In particular, FIGS. 5A-5B are preload sequences 40 with preloaded pressure values 32 and FIGS. 5C-5D are preload sequences 40 with preloaded time constants 44. FIG. 5A illustrates a pressure or loading curve 62 corresponding to a harder surface (e.g., bone) while FIG. 5B illustrates a pressure or loading curve 62 corresponding to a softer surface (e.g., fat, muscle). Stated differently, the loading curve 62 in FIG. 5A has a steeper curve or larger rise/run, which indicates a harder surface, while the loading curve in FIG. 5B has a less steep curve or lower rise/run, which indicates a softer surface. In each case, the device 10 is set with a preloaded pressure value 32 such that a patient 2 applies the probe 18 tip 20 against the portion of the body 5 to undergo treatment. The device 10 begins taking pressure readings that correspond with time upon an initial pressure value being sensed by the device and the patient 2 continues to apply pressure until the preload pressure value 32 is reached. At this point, the device 10 stops taking pressure readings.

Similarly to as described above, FIG. 5C illustrates a pressure or loading curve 62 corresponding to a harder surface (e.g., bone) while FIG. 5D illustrates a pressure or loading curve 62 corresponding to a softer surface (e.g., fat, muscle). In this case, the device 10 is set with a preloaded time constant 44 such that a patient 2 applies the probe 18 tip 20 against the portion of the body 5 to undergo treatment. The device 10 begins taking pressure readings that correspond with time upon an initial pressure value being sensed by the device and the patient 2 continues to apply pressure until the preload time constant 44 is reached. At this point, the device 10 stops taking pressure readings.

As indicated in FIG. 4A, the absorption rate is then converted to a frequency [block 408], wherein the frequency is a predictor of the fundamental frequency of the part of the body 5 that was analyzed. As discussed previously, the profile of the loading curve 62 can predict certain characteristics related to the body part 5 of the patient 2 to determine whether the analyzed body part 5 was soft tissue, rigid bone, tough muscle, etc. Specifically, the loading curve 62 can be used to determine a frequency of absorption of the patient's 2 skin in the area that the device 10 analyzed. This frequency can then be used to determine a treatment plan for the patient 2. With respect to determining a frequency of the patient's 2 skin, the rise/run or rise time (ΔP/ΔT or Delta P/Delta t) is used to calculate a treatment frequency because the rise time is an indicator of energy absorption. The value for the rise time is based upon pressure input readings from 10% to 90% from the quiescent value to the point that enough pressure is applied to meet the preload pressure value 32. Generally speaking, the higher the rise time of the loading curve 62, the harder the surface and the higher the treatment frequency. To determine a frequency based on the rise time, the following information is used:
Calculated frequency is a subharmonic frequency of FT*1/(ΔP/ΔT) where FT is a Fourier Transform or analogous method based on the pressure sensing method used and the frequency calculation.
   As with FIGS. 5A-5D, which depict linear loading curves 62, a calculated frequency can be directly converted using the aforementioned calculation. In cases where the loading curve 62 is not linear, a useable and beneficial frequency can still be obtained.

As can be understood from FIG. 4B, the calculated frequency is compared to treatment plan frequencies of preloaded treatment plans [block 410] that are stored in the microprocessor 36 and a suitable treatment plan is selected based on the comparison [block 412]. The system 1 can compare the calculated frequency to the treatment plan frequencies and select a treatment plan with a frequency that most closely corresponds to the calculated frequency [blocks 410-412]. Additionally, other methods can be used to compare and select a treatment plan based on a comparison of frequencies between the calculated frequency and treatment plan frequencies 66 of FIG. 6.

As seen in FIG. 6, the stored treatment plans 66 can be a list or grouping of treatment plan frequencies and corresponding treatment parameters. In this particular embodiment, the treatment plans 66 are divided into Treatment 1 and Treatment 2. Treatment 1 corresponds to a frequency range of 0.1 Hz to 3.9 Hz, while Treatment 2 corresponds to a frequency range of 4.0 Hz to 12.0 Hz. Thus, a calculated frequency may be, for example, 3.2 Hz. The device 10 then compares the calculated frequency to the treatment plans 66 and determines which treatment plan 66 the calculated frequency matches. In the embodiment of FIG. 6, a calculated frequency of 3.2 Hz would match a frequency range of 0.1 Hz to 3.9 Hz since 3.2 Hz is within the aforementioned range of frequencies. Thus, in this example, the device 10 would select Treatment 1 to perform on the patient 2. Treatment parameters for each of the treatment plans 66 define the treatment plan 66 and can include sub-harmonic frequencies, resonant frequencies, power settings, pulse frequencies, time duration, number of pulses etc. The various treatment parameters are such that each corresponds with the treatment plan frequency in order to provide therapeutic benefits to a patient 2 when administered to the analyzed part of the body 5.

C. Applying the Treatment Plan to the Analyzed Part of the Patient's Body.

As seen in FIG. 4B, after the data acquisition system 34 analyzes the data and selects an appropriate treatment plan, the device 10 then applies oscillating percussion to the patient's body 5 according to the treatment plan [block 414]. As can be understood from FIGS. 1-3, the embedded code in the microprocessor 36 signals the device's components (e.g., electromagnetic coil 26, armature 28) to begin delivering the treatment according to the plan parameters. In such a way, the device 10 switches from a diagnostic device to a therapeutic delivery device. In a certain embodiment, the treatment plan includes repetitively accelerating the armature 28 to impact the anvil 22 thereby accelerating the probe 18 to oscillate at treatment plan frequencies between 0.1 and 12 Hertz (Hz) and at pulse frequencies of about 0.1 Hz. The pulse frequencies can be delivered as a burst or in amplitude modulated form. Other treatment plan frequencies and/or pulse frequencies are possible based on corresponding frequencies of the analyzed part of the patient's body 5. The device 10 is reset by either the completion of the treatment plan (e.g., number of pulses applied is complete, time duration is complete) [block 416], or the releasing of pressure on the pressure sensor 30 (e.g., the patient 2 decides to end treatment by releasing pressure exerted by the device 10 on the skin 5) [block 416]. In a certain embodiment, the device 10 has no memory of treatment plans that were previously utilized or frequencies of the body part 5 that underwent treatment. Each successive application of the device 10 to a body part 5 to undergo treatment will cause the device to undergo a preload sequence 40 in order to determine characteristic frequencies associated with the body part 5 in order to select an appropriate treatment plan. In another embodiment, the history of the treatment plans utilized can be stored in the memory 52 of the microprocessor 36.

In a certain embodiment, a switch mechanism 42 can be utilized to change the function of the device 10 from diagnostic to therapeutic. In one example, the switch 42 is depressed during the preload sequence 40 (i.e., time between initial pressure until the preloaded pressure value is reached). An auditory cue can signal the user 2 that the preload sequence 40 is complete, whereby the user 2 can decrease the applied pressure of the device 10 on their body 5. The combination of the completion of the preload sequence 40 and the decrease in applied pressure can release the switch 42 and signal the device 10 to calculate the frequency and/or power and select an appropriate treatment plan. The treatment plan can automatically begin applying the treatment plan according to the treatment parameters. Alternatively, the switch 42 can automatically release upon the completion of the preload sequence 40. In this way, the user can apply even pressure from the time that the preload pressure 32 is met until the treatment plan is complete.

In another embodiment, the device 10 utilizes a preloaded time constant 44 as opposed to a preloaded pressure value 32. The device 10 measures pressure and time during the preload sequence 40, as in other embodiments, but the preload sequence 40 is completed based on a preloaded time constant 44 (e.g., 3 seconds). During the preload sequence 40, which is triggered by an initial pressure reading, the device 10 measures pressure and corresponding time values until the preload time constant 44 is met. In such a way, the user 2 can apply varying amounts of pressure during the preload sequence 40. As the preload sequence completes 40 (i.e., preload time constant 44 is complete), the device 10 can then calculate frequency and/or power, compare/select a treatment plan, and apply the treatment as in other embodiments described herein.

FIG. 2 illustrates an example microprocessor 36 that may be useful in implementing the presently disclosed technology. A general purpose microprocessor 36 is capable of executing a computer program product to execute a computer process. Data and program files 56 (e.g., computer software code) may be input to the microprocessor 36, which reads the files and executes the programs therein. Some of the elements of a general microprocessor 36 are shown in FIG. 2 wherein a microprocessor 36 is shown having an input/output (I/O) section 46, a Central Processing Unit (CPU) 48, timers 50, program memory 54 and a data memory section 52. There may be one or more microprocessors 36, such that the microprocessor 36 of the system 1 comprises a single central-microprocessing unit 36, or a plurality of microprocessing units, commonly referred to as a parallel processing environment. The presently described technology is optionally implemented in software devices loaded in memory 52.

The I/O section 46 is connected to one or more user-interface devices (e.g., pressure sensor 30) through the data acquisition system 34. Computer program products containing mechanisms to effectuate the systems and methods in accordance with the presently described technology may reside in the memory section 52 of the microprocessor 36.

II. System for the Treatment of Skin and Tissue.

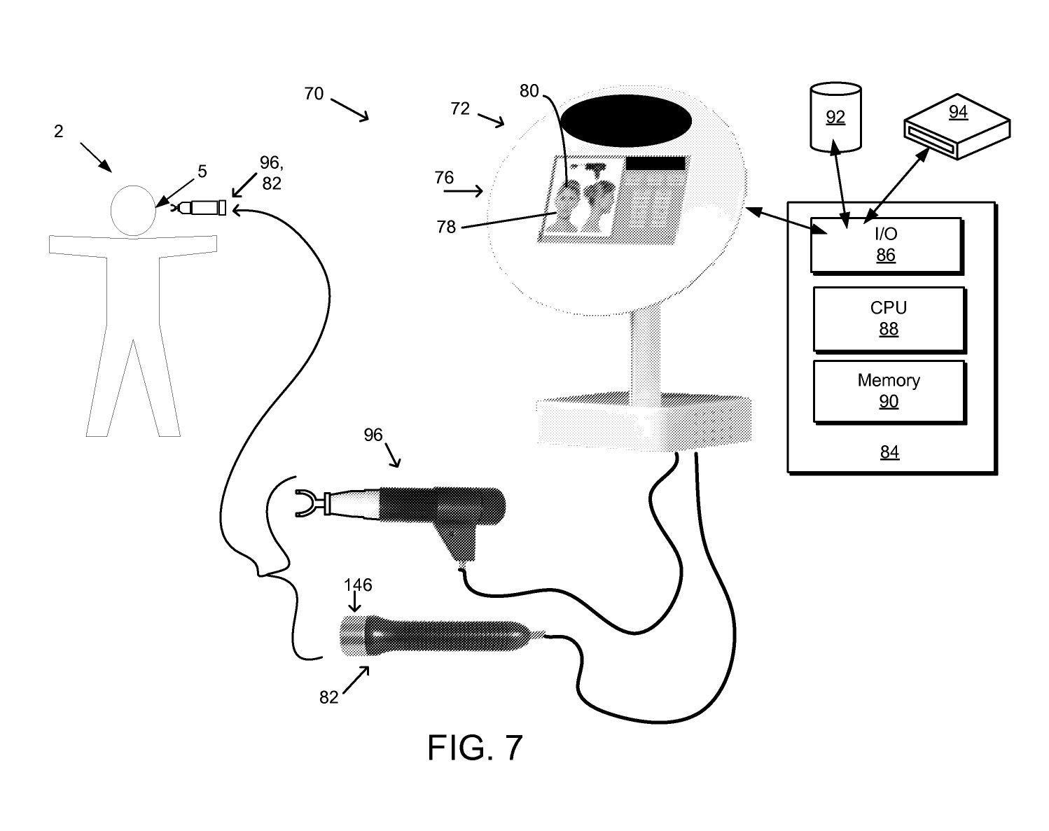

Moving on to a system incorporating the device, reference is made to FIG. 7, which is a system 70 for treating skin and underlying tissues for improved health and appearance.

Aspects of the system 70 may involves a percussive impulse device 96 along with other treatment devices. In addition, the devices may be coupled with a computer 72 running software 74 that is displayed on a display unit 76 (e.g., monitor) in a graphical user interface (“GUI”) 78 that allows an operator to select treatments based on interacting with menus and various commands of the GUI 78. In an aspect, the operator may specify a particular treatment mode and particular facial landmarks to treat. A generic facial image 80 (i.e., not the patient's face) may be displayed within the GUI 78 to show the selected facial landmarks to treat. The operator may then specify the control settings of the devices through the GUI. Alternatively, the devices may be preset with certain control settings. The control settings of the devices may be used to configure the devices during the administration of the treatment to the patient 2.

As seen in FIG. 7, the system 70 includes the computer 72, the percussive impulse device 96, and an pressure wave (RF energy) generator (e.g., sound wave generator) 82. The computer 72 reads files and executes programs therein. The computer 72 includes a processor 84 having an input/output (I/O) 86, a central processing unit (CPU) 88, and memory 90. The I/O section 86 is connected to one or more user-interface devices (not shown), a display unit 76, a storage unit 92, and a disk drive 94.

A. Percussive Impulse Device.

The percussive impulse device 96 of this system 70 may include one of at least two embodiments of a percussive impulse device 96.

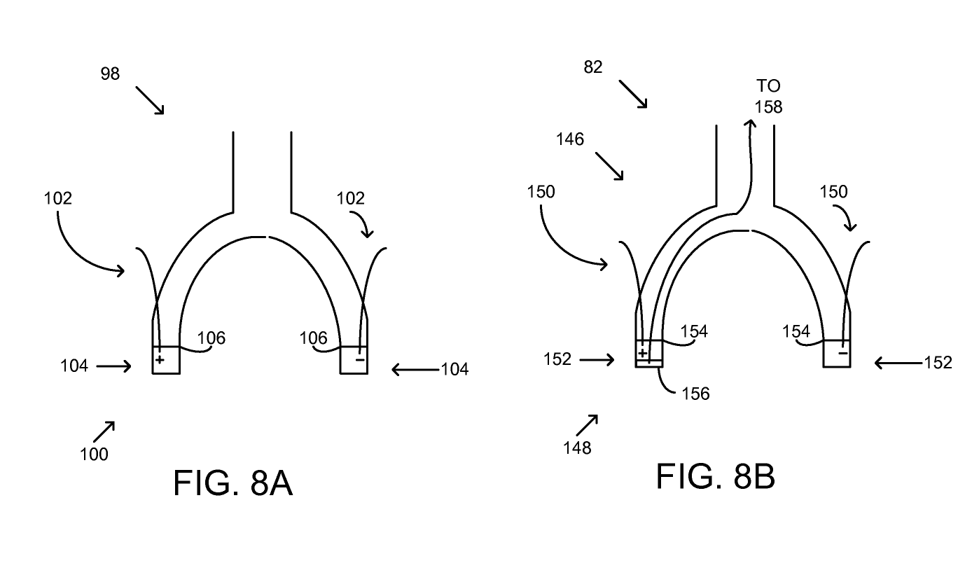

In one aspect, the percussive impulse device 96 is the same as the device 10 described in reference to FIGS. 1-6 and [blocks 402-416]. In addition to the functionality as described above, the device 96 of the present system 70 may also include hardware to perform microcurrent electrical neuromuscular stimulation (“MENS”). MENS functions by applying a small electrical signal (e.g., current of <1 mA) into nerves and muscles of the body using electrodes to transmit the signal. MENS may aid in the therapeutic treatment of joint and ligament repair, muscle relaxation, and pain, among other treatment modalities. In addition, MENS may be considered an anti-aging treatment as it may diminish the appearance of fine lines and wrinkles by toning and firming the patient's skin. Referring to FIG. 8A, which is a percussive impulse treatment head 98 that may be used with the percussive impulse device 96 that includes hardware to facilitate MENS. The percussive impulse treatment head 98 includes a dual-head probe tip 100 with a pair of leads 102 that are electrically coupled with electrically metal ends 104 of the dual-head probe tip 100 such that one tip 100 of the dual-head probe tip 100 will act as a positive lead and one tip 100 of the dual-head probe tip 100 will act as a negative lead. The percussive impulse treatment head 98 may additionally include an insulating layer 106 that insulates the metal ends 104 from the rest of the probe tip 100. The metal ends 104 may act as conductive electrodes in performing the MENS. And, when the device 96 utilizes MENS, a conductive gel may be used to aid in the current flow between the conductive ends 104 of the device 96. In this aspect, the percussive impulse device 96 may perform percussive impulses to a patient 2 and may also perform MENS to a patient 2.

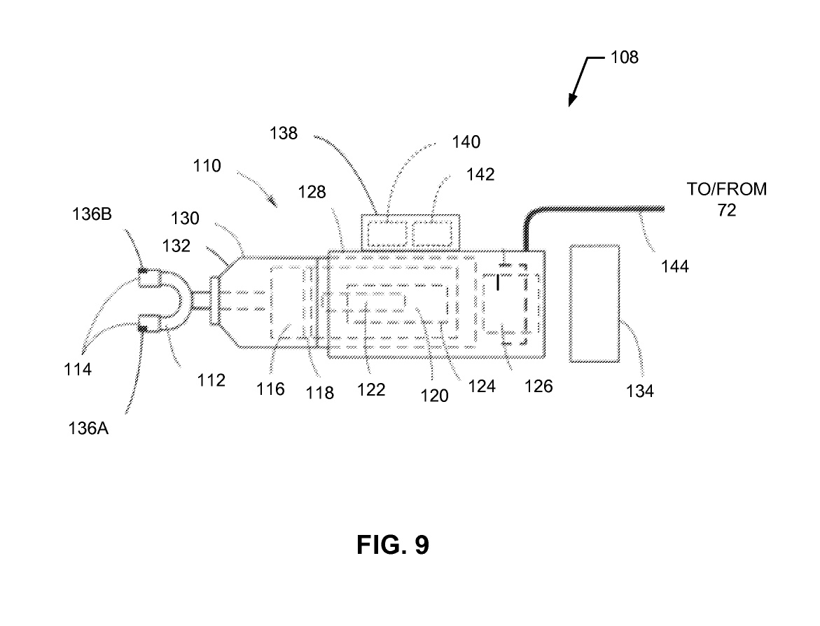

In another aspect, the percussive impulse device 96 may include a device that is different from the impulse device 10 described above. FIG. 9 shows a side view of another embodiment of a percussive impulse device 108. The percussive impulse device 108 includes an impulse and sensing head 110 that contacts the facial tissues of the patient to deliver the mechanical force impulses and/or electrical pulses. The impulse and sensing head 110 includes a probe 112 with one or more tips 114 that contact the facial tissues of the patient 2. A piezoelectric sensor 116 is firmly attached to the probe 112, and an anvil 118 is firmly attached to the piezoelectric sensor 116. A solenoid assembly 120 containing an armature 122 inserted without attachment into an electromagnetic coil 124 is also included in the impulse and sensing head 110. A pressure sensor 126 may be attached to the head 110 and configured so that when the probe 112 is pressed against the patient's facial tissue and reaches a predetermined pressure, the pressure sensor 126 causes a release of a burst of current to energize the electromagnetic coil 124. When the electromagnetic coil 124 is energized, the armature 122 is accelerated to impact the anvil 118 and thereby produce a force impulse, which travels through the piezoelectric sensor 116 and probe 112, thereby transmitting the force impulse to the facial tissues of the patient in contact with the probe 112.

Referring still to FIG. 9, the percussive impulse device 108 may further include an elongated and generally cylindrical housing 128 which has an insert 130 that tapers to form a generally conical configuration at the forward end 132. The other end of the housing 128 is provided with a cylindrical closed end 134. The housing 128 and the closed end 134 may be separately connected by a screw threaded connection to provide access into the interior of the housing 128 and to separate the components of the facial stimulator instrument 108 for repair, replacement and the like. After the housing 128 is unscrewed from closed end 134, it may slide back and insert 130 may also be unscrewed from the housing 128.

The design of the percussive impulse device 108 also provides the ability to monitor the force impulses and electrical stimulation as they are applied to the facial tissues. The piezoelectric sensor 116 may monitor the force impulses as they are applied to assess the response of the facial tissue of the patient to the application of the force impulses; the signals produced by the piezoelectric sensor 116 may be output to the computing device 72 for processing. The pressure sensor 126 may output data characteristic of the pressure of the probe 112 in contact with the facial tissue of the patient to the computing device 72 for processing.

In an aspect, the percussive impulse device 108 receives signals from the computing device 72 that control the production and delivery of force impulses and/or electrical stimulation in accordance with a treatment protocol selected. Thus, in response to a certain frequency that is registered by the piezoelectric sensor 116, the computing device 72 may signal the device 108 to deliver force impulses and/or electrical stimulation according to corresponding frequencies or subharmonic frequencies thereof.

The probe 112 may further include one or more electrodes 136A and 136B attached to the one or more tips 114 such that the electrodes 136A and 136B contact the skin of the patient 2 in order to deliver an electrical stimulation, such as a MENS treatment, to the facial tissues. An electrical stimulation unit 138 may employ a high frequency oscillator 140 and a power amplifier 142 to generate a series of high frequency electrical pulses that are then delivered to the facial tissues of the patient via the electrodes 136A and 136B contacting the patient's skin. The device 108 may obtain power from a computing device 72 via an electrical cable 144. Alternatively, electrical power may be supplied through an additional electrical cord (not shown) that may be electrically connected to an external power supply, suitable electrical outlet, or the like, which extends into the housing 128.

B. Pressure Wave Generator.

Referring back to FIG. 7, the system 70 includes a pressure wave generator 82 that is in electrical communication with the computer 72 and its componentry. The pressure wave generator 82 is configured to deliver a pressure wave (e.g., sound wave) to a tissue 5 of the patient 2, such as, for example, the face, neck or other cosmetically treated skin regions of the patient. The pressure wave generating device 82 may be in the form of a handheld wand, as shown, or may be equipped with a strap or other arrangement to allow the pressure wave generating device 82 to be strapped to the patient 2. The pressure wave generating device 82 may be capable of generating a wide range of pressure energy (e.g., sound energy), including ultrapressure (e.g., ultrasound), and short waves through long waves. In one embodiment, the pressure energy generated by the pressure wave generating device 82 is a long wave pressure wave.

Typically, a conductive gel is applied to the patient's skin tissue 5 to aid in the transmission of the pressure wave to the patient's skin and the underlying tissues and muscle. The pressure wave generating device 82 is configured to deliver a pressure wave having a frequency between 500 kHz and 1.5 MHz. In a preferred embodiment, the pressure wave generating device 82 delivers an 800 kHz pressure wave to the patient 2. Preferably, the pressure wave has sinusoidal waveform, although other waveforms and wave profiles may also be generated.

In various embodiments, the pressure wave generated by the pressure wave generating device 82 may be modulated to transmit the pressure wave throughout the patient's skin and the underlying tissues and muscle. For example, the pressure wave may be pulsed at a lower frequency. In one example, the pressure wave having a frequency between 500 kHz and 1.5 MHz may be pulsed at lower frequency between 1 Hz and to 300 Hz to transmit the energy of a pressure wave in frequencies known to evoke neurological potentials. In another example, the pressure wave having a frequency of about 900 kHz may be pulsed between about 4 Hz and about 12 Hz. The pulsing of the wave also reduces heat build-up in the tissues and is intended to maximize the mechanical influence of the lower frequencies on the tissues and/or nerves. In certain aspects, the pressure wave may be generated continuously and modulated. Square waves or sinusoidal waves may be provided by the device 82.

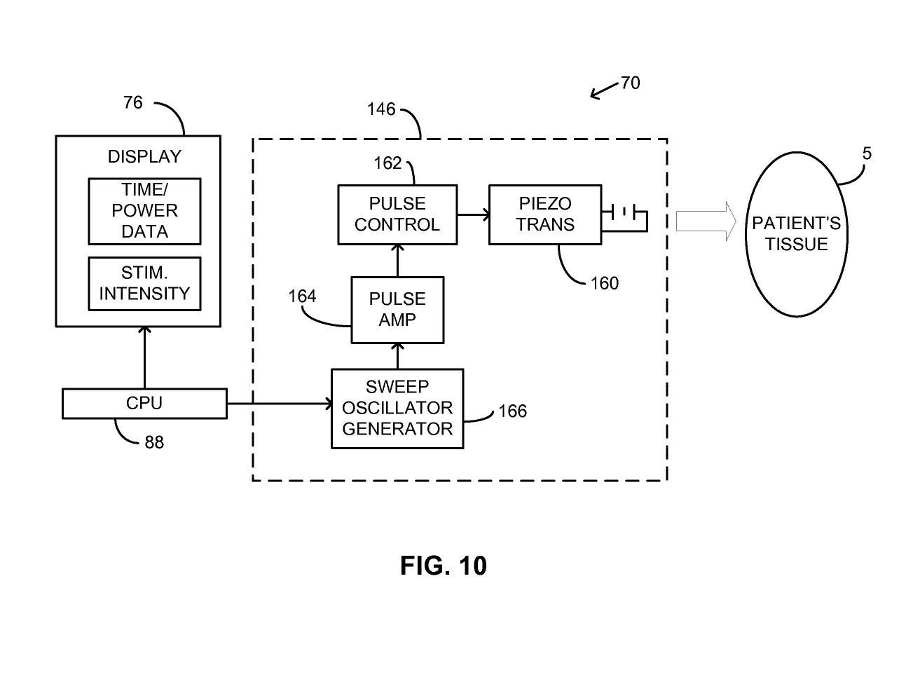

As can be understood from FIGS. 7 and 10, the pressure wave generating device 82 may include an RF head 146 that includes a piezoelectric transducer 160 that is electrically coupled with a pulse control 162 that is electrically coupled to a pulse amplifier 164 that is electrically coupled to a sweep oscillator generator 166. The RF head 146 is electrically coupled to the CPU 88 and display 76 described above with respect to FIG. 7. As seen in FIG. 10, the RF head 146 is applied to a patient's tissue 5 and pressure waves are generated to the tissue 5.

When the RF head 146 is applied to the patient tissue, the system 70 is configured to cause the RF head 146 to administer RF energy to the patient tissue 5 at the identified RF frequency (e.g., 600 KHz) over a range of pulse frequencies by the sweep oscillator generator 166 and pulse control 162 causing the administered 600 KHz RF energy to pulse at a series of frequencies in a step fashion across a range of pulse frequencies generated by the oscillator generator 166. In one embodiment, the generator 166 is configured to cause the RF head 146 to administer RF energy at the identified RF frequency (e.g., 600 KHz) to the patient 2 over a range of pulse frequencies between approximately 1 Hz and approximately 300 Hz at steps that are defined in the software via an algorithm that allows the user to determine the scan time, in one embodiment, between approximately 1 Hz and approximately 30 Hz. Optimum scan times are established for each tissue type and/or face, neck, etc. region in a database from empirical data. For example, a database contained in the memory of the system can be used to pre-select scan times based on the tissue or area of concern entered into the interface of the system, each tissue type or area of concern being correlated in the data base to specific scan times.

In addition to the pressure wage generating functions of the device 82 and as seen in FIG. 8B, the pressure wave generator 82 may include hardware to employ MENS treatments. In particular, the wave generating device 82 may include a dual-head probe tip 148 with a pair of leads 150 that are electrically coupled with electrically conductive metal ends 152 of the dual-head probe tip 148 such that one tip 148 of the dual-head probe tip 148 will act as a positive lead and one tip 148 of the dual-head probe tip 148 will act as a negative lead. The pressure wave generator may additionally include an insulating layer 154 that insulates the metal ends 152 from the rest of the probe tip 148. The metal ends 152 may act as conductive electrodes in performing the MENS. When applying pressure waves, the pressure wave generator 82 may include a piezoelectric crystal 156 at one or both tips 148 of the device 82. The piezoelectric crystal 156 produces ultrasonic waves when an alternating current is applied across it and, thus, the crystal 156 may be electrically coupled to a power supply 158 either within the device 82, the computer 72, or within an electrical outlet (not shown). When the device 82 employs MENS, a conductive gel may be used to aid in the current flow between the conductive ends 152 of the device 82. In this aspect, the pressure wave generator 82 may apply pressure waves to a patient 2 and may also apply MENS to a patient 2.

C. Employing the System.

Certain embodiments of the system 70 may include various treatment plans that are stored in the memory 90 of the computer 72. The system 70 is configured to apply therapy to the trigeminal nerve, certain connecting points of the facial muscles, and facial skin and muscles at certain facial landmarks and locations. While this therapy is described below as taking place in an order wherein the trigeminal nerve exit points are first measured and treated followed by the facial muscle connecting points and the facial skin and muscles, these measurements and therapies may occur in any order and certain therapies may be omitted entirely.

To implement the treatment plans, an operator may interact with the GUI 78 of the display 76 in one of many ways to queue the system to begin the particular treatment plan. The following discussion will focus on an example of three possible treatment plans for use within the system 70.

i. Treatment Plan 1.

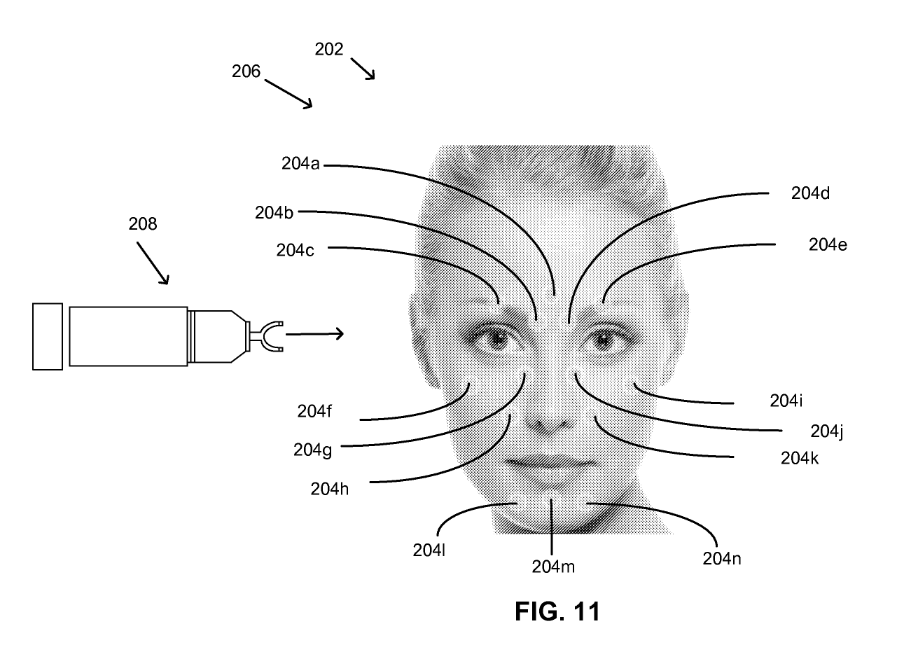

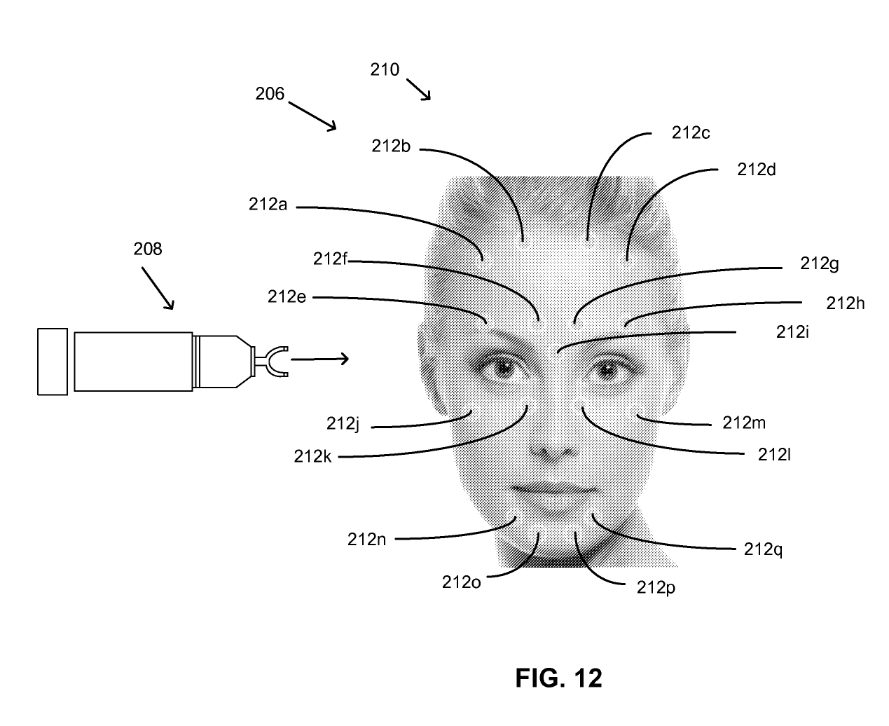

A first treatment plan 202 may include an application of percussive force impulses to the facial nerves of a patient 2. In particular and as seen in FIG. 11, force impulses are delivered to areas on the face that correspond to the trigeminal nerve exit points 204a-204n. When an operator interacts with the GUI 78, the display 76 may show a generic facial image 206, as seen in FIG. 11, that will indicate the facial nerve areas to treat with a percussive impulse device 208. In response to the display of the image 206, an operator will first analyze the patient's tissue 5 to determine an appropriate frequency to apply based on one of a number of methods. Next, the operator will deliver the treatment according to the analysis.

In a first embodiment of the first treatment plan 202, the analysis and treatment is performed by the percussive impulse device 10 as described in reference to FIGS. 1-6. In particular, the operator will apply the probe tip 20 of the device 10 to each nerve exit point 204a-204n and the device 10 will calculate a frequency for that particular area based on the rise time associated with the facial tissue 5. From the rise time, a frequency will be calculated and that frequency will be compared with treatment plan frequencies of preloaded treatment plans 66. A treatment plan frequency will be selected and the device 10 will begin applying the treatment based on the parameters in the plan 66. This step is then subsequently repeated for each nerve exit point 204a-204n. Alternatively, instead of assessing and treating each point 204a-204n in succession, a single point may be assessed in each of a group of points (e.g., 204a-204e being a group, 204f-204k being another group, and 2041-204n being another group) and an applicable treatment will be administered to each point in the group based off of the assessment of the single point of the group.

In a second embodiment of the first treatment plan 202, the analysis and treatment is also performed by the percussive impulse device 10 as described in reference to FIGS. 1-6, but the analysis function is eliminated and the device 10 performs according to predefined parameters (e.g., frequency, time length). In this case, the predefined parameters may be linked with the neural treatment plan such that for each nerve exit point, or certain nerve exit points, the device 10 will function according to the predefined parameters. For example, the device may function with a subset of three predefined plan parameters: frequency X1 for nerve exit points 204a-204e, frequency X2 for nerve exit points 204f-204k, and frequency X3 for nerve exit points 2041-204n. As seen in FIG. 11, the subset of three predefined plan parameters corresponds to an upper portion of the face (204a-204e), a mid-portion of the face (204f-204k), and a lower portion of the face (2041-204n). Other parameters are possible as well.

In a third embodiment of the first treatment plan 202, the analysis and treatment is performed by the percussive impulse device 108 as described in FIG. 9. In this case, the device 108 is applied to the patient's skin 5 in the area of the nerve exit points 204a-204n with a certain amount of pressure until the electromagnetic coil 124 fires. The resulting wave is registered by the computing device 72 and a corresponding frequency is determined. The device 108 then begins treating the particular nerve exit point based on the determined frequency. These steps may then be subsequently applied to each additional nerve exit point 204a-204n. Alternatively, instead of assessing and treating each point 204a-204n in succession, a single point may be assessed in each of a group of points (e.g., 204a-204e being a group, 204f-204k being another group, and 2041-204n being another group) and an applicable treatment will be administered to each point in the group based off of the assessment of the single point of the group.

According to one or more embodiments of the first treatment plan 202, the frequency range of applied frequencies may be between 0.1 Hz and 4 Hz. Additionally, the applied frequency may be a first subharmonic frequency that is above 4 Hz.

In addition to the treatment plans discussed above, any or all of the embodiments of the first treatment plan 202 may additionally include the application of MENS.

Once all of the nerve exit points 204a-204n have been treated, the system 70 may automatically queue the operator to exit the particular treatment module or the operator may manually select another treatment module.

ii. Treatment Plan 2.

A second treatment plan 210 may be include an application of percussive force impulses to the facial muscles of a patient 2. In particular and as seen in FIG. 12, force impulses are delivered to areas on the face that correspond to facial muscle connecting points 212a-212q. When an operator interacts with the GUI 78, the display 76 may show a generic facial image 206, as seen in FIG. 11, that will indicate the facial muscle areas to treat with a percussive impulse device 208. In response to the display of the image 206, an operator will first analyze the patient's tissue 5 to determine an appropriate frequency to apply based on one of a number of methods. Next, the operator will deliver the treatment according to the analysis.

Similarly to as described above with respect to FIG. 11, there are at least three possible embodiments of the second treatment plan 210. In the first embodiment of the second treatment plan 210, the analysis and treatment is performed by the percussive impulse device 10 as described in reference to FIGS. 1-6 and as above. The only difference being that the points of contact between the device 208 and the patient's tissue 5 are the facial muscle connecting points 212a-212q instead of the trigeminal nerve exit points 204a-204n.

The second embodiment of the second treatment plan 210 is also similar to the second embodiment of the first treatment plan 202, described above except that the treatment is performed on muscles locations as opposed to nerve locations.

And again, the third embodiment of the second treatment plan 210 is similar to the third embodiment of the first treatment plan 202, described above, except that the treatment is performed on muscles locations as opposed to nerve locations.

According to one or more embodiments of the second treatment plan 210, the frequency range of applied frequencies may be between 4 Hz and 12 Hz. Additionally, the applied frequency may be a first subharmonic frequency that is above 10 Hz.

In addition to the treatment plans discussed above, any or all of the embodiments of the first treatment plan 202 may additionally include the application of MENS.

Once all of the muscle exit points 204a-204n have been treated, the system 70 may automatically queue the operator to exit the particular treatment module or the operator may manually select another treatment module.

iii. Treatment Plan 3.

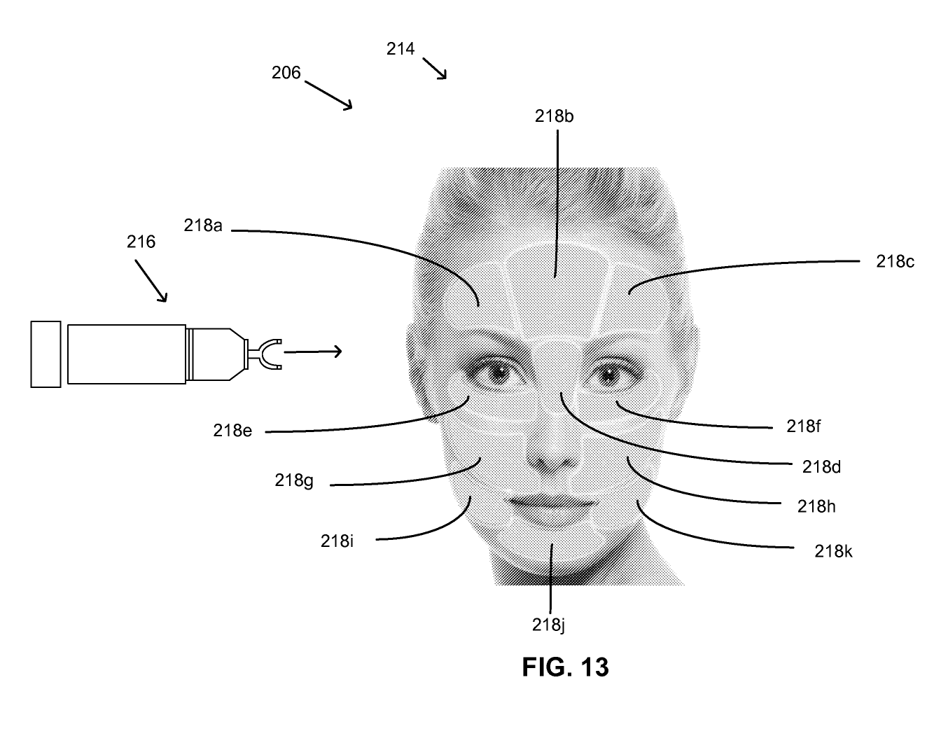

A third treatment plan 214 may include an application of pressure waves (e.g., ultrasonic waves) via a pressure wave generator 216 to regions of a patient's face. In particular and as seen in FIG. 13, pressure waves are delivered to areas on the face that correspond to facial nerves and muscles 218a-218k. When an operator interacts with the GUI 78, the display 76 may show a generic facial image 206, as seen in FIG. 11, that will indicate the facial areas to treat with the pressure wave generator 216. In response to the display of the image 206, an operator may first analyze the patient's tissue 5 in the identified areas to determine an appropriate frequency to apply based on one of a number of methods. Next, the operator will deliver the treatment according to the analysis.

In a first embodiment of the third treatment plan 214, the pressure wave generator 216 as described in FIGS. 7 and 10 may be used to deliver treatment to the facial locations 218a-218k according to predefined parameters. In this embodiment, the generator 216 may deliver RF energy to the facial locations 218a-218k at 900 KHz with a pulse rate within a range of 4 Hz to 12 Hz. The pulsed rate may be as described above with respect to the pressure wave generator 216 and may be pulsed in a burst or amplitude modulated form, among other possible forms.

In addition to the treatment plans discussed above, any or all of the embodiments of the first treatment plan 214 may additionally include the application of MENS.

D. Graphical User Interface.

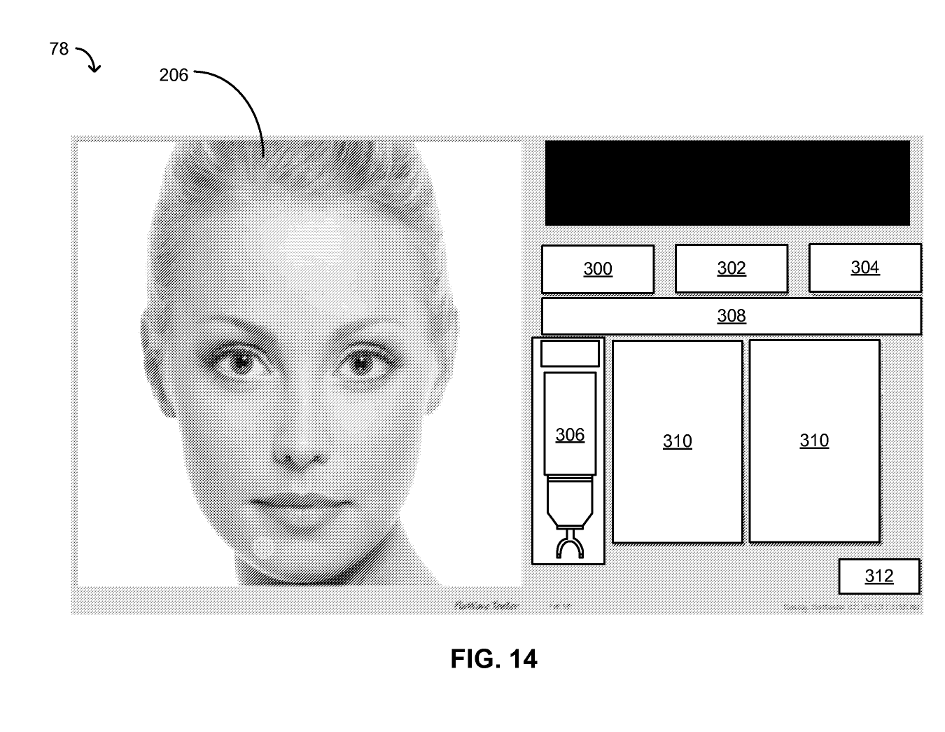

As described above, the various treatment plans may be controlled by an operator interacting with the GUI 78 of the computing device 72. In particular, and referring to FIG. 14, which is a screenshot of the GUI 78, the system 70 may be controlled as follows. In the upper left of the right hand side of the GUI 78, the treatment mode 300 indicates which treatment plan is selected. For example, the treatment mode 300 may indicate “T1” for the first treatment plan 202. The icon to the right of the treatment mode 300 is the timer 302. The timer 302 may indicate, for example, the total time elapsed per client or the total time elapsed per treatment plan. Moving to the right is an ultrasound specific timer 304, which indicates how long the pressure wave generator 216 may remain at a particular location on the patient. In the center of the screen is a treatment type indicator 306, which indicates which treatment head is being used in the particular treatment plan. In this case, a percussive impulse device is displayed. On the left side of the GUI 78 is the generic facial image 206 in which facial landmarks are overlaid to indicate a position of treatment (e.g., neural, muscular). In the center of the right hand side of the GUI 78 is a status bar 308, which may depict “Start Treatment” or “Stop Treatment.” The bottom right hand side of the GUI 78 include treatment parameters 310, such as current, frequency, power, preload, frequency mode, total number of impacts, previous number of impacts on previous application, etc. Finally, in the bottom right of the GUI 78 is an exit button 312, which returns the operator to a beginning menu screen.

The above specification, examples, and data provide a complete description of the structure and use of example implementations of the invention. Various modifications and additions can be made to the exemplary implementations discussed without departing from the spirit and scope of the presently disclosed technology. For example, while the implementations described above refer to particular features, the scope of this disclosure also includes implementations having different combinations of features and implementations that do not include all of the described features. Accordingly, the scope of the presently disclosed technology is intended to embrace all such alternatives, modifications, and variations together with all equivalents thereof.

1. A system for administering a therapeutic treatment to a portion of a patient body, the system comprising:
a pressure sensor; a treatment head; and at least one computer processor in operable electrical communication with both the pressure sensor and treatment head, wherein:
a) when a treatment tip of the treatment head is applied against the portion of the patient body, the at least one computer processor receives time dependent pressure readings from the pressure sensor corresponding to pressure applied by the treatment tip against the portion of the patient body;
b) the at least one computer processor calculates from the time dependent pressure readings a test frequency via an algorithm stored in the system;
c) the system compares the test frequency to treatment plan frequencies of stored treatment plans stored in the system and selects a selected treatment plan from the stored treatment plans based on the comparison; and
d) when the system is used to administer the therapeutic treatment to the portion of the patient body, the system causes the treatment head to operate according to the selected treatment plan.

2. The system of claim 1, wherein the algorithm is based on a change in pressure divided by a change in time.

3. The system of claim 2, wherein the algorithm includes a transform.

4. The system of claim 1, wherein the time dependent pressure readings are defined by a start time and an end time, wherein the pressure sensor begins signaling time dependent pressure readings at the start time, and wherein the pressure sensor stops signaling time dependent pressure readings at the end time.

5. The system of claim 4, wherein the pressure sensor stops sending time dependent pressure readings at the end time when the pressure sensor senses a preloaded pressure value.

6. The system of claim 1, wherein the treatment head comprises: an armature; an anvil; and a probe terminating in the treatment tip, wherein the treatment head is configured to provide oscillatory percussion therapy by way of the armature striking the anvil and delivering a force impulse wave that transmits through the anvil and into the probe, whereby the probe transfers the wave into the portion of the patient body when the probe is applied to the portion of the patient body during the administration of the therapeutic treatment.

7. The system of claim 6, wherein the computer processor, the pressure sensor, the armature, the anvil, and at least a portion of the probe are enclosed within a hand-held housing of the treatment head.

8. The system of claim 6, wherein displacement of the probe corresponds to pressure applied to the pressure sensor.

9. The system of claim 1, wherein the pressure sensor is a proximity sensor.

10. The system of claim 1, wherein the computer processor and the pressure sensor are enclosed within a hand-held housing of the treatment head.

11. A system for administering a therapeutic treatment to a portion of a patient body, the system comprising:
a) a microprocessor comprising:
i) an input configured to receive information associated with the therapeutic treatment,
ii) an output configured to communicate information associated with the therapeutic treatment, and
iii) a memory in electrical communication with a CPU, the memory including treatment plans associated with the therapeutic treatment of the portion of the patient body and algorithms for comparing and selecting treatment plans, the CPU in electrical communication with the input and the output;
b) a pressure sensor in electrical communication with the microprocessor, wherein the pressure sensor is configured to detect applied pressure and communicate time dependent pressure readings to the microprocessor;
c) a percussive impulse system comprising: an armature; an anvil; and a probe, wherein the percussive impulse system is configured to provide oscillatory percussion therapy by way of the armature striking the anvil and delivering a force impulse wave that transmits through the anvil and into the probe, whereby the probe transfers the wave into the portion of the patient body when the probe is applied to the portion of the patient body during the administration of the therapeutic treatment,
d) wherein the system is configured to: i) calculate a test frequency via an algorithm based on the time dependent pressure readings, the algorithm being stored in the system; ii) compare the test frequency to treatment plan frequencies of the treatment plans stored on the system; iii) select a selected treatment plan by selecting one of the treatment plans based on the comparison between the test frequency and the treatment plan frequencies; and iv) apply the selected treatment plan via the percussive impulse system by performing the oscillatory percussion therapy according to a treatment plan frequency of the selected treatment plan.

12. The system of claim 11, wherein the pressure sensor is a proximity sensor.

13. The system of claim 11, wherein the microprocessor, the pressure sensor, the armature, the anvil, and at least a portion of the probe are enclosed within a hand-held housing.

14. The system of claim 11, wherein displacement of the probe corresponds to pressure applied to the pressure sensor.

15. The system of claim 11, wherein the algorithm is based on a change in pressure divided by a change in time.

16. The system of claim 15, wherein the algorithm includes a transform.

17. The system of claim 11, wherein the time dependent pressure readings are defined by a start time and an end time, wherein the pressure sensor begins signaling time dependent pressure readings at the start time, and wherein the pressure sensor stops signaling time dependent pressure readings at the end time.

18. The system of claim 17, wherein the pressure sensor stops sending time dependent pressure readings at the end time when the pressure sensor senses a preloaded pressure value.

19. A system for therapeutic treatment of a portion of a patient body, the system comprising:
a) a display device;
b) at least one processing device in electrical communication with the display device and comprising:
an input; an output; a memory; and a CPU in electrical communication with the input, the output, and the memory, the memory including software for operating a GUI displayed on a display device and configured to be interacted with by an operator, wherein treatment plan parameters are stored in the memory and displayed on the display device upon selecting via the GUI a first treatment plan or a second treatment plan, the first and the second treatment plans stored in the memory, the treatment plan parameters for the first treatment plan comprising treatment locations corresponding to facial nerve exit points, the treatment plan parameters for the second treatment plan comprising treatment locations corresponding to facial muscle connection points; and
c) a percussive impulse device electrically coupled with the at least one processing device and comprising a pressure sensor and a probe, wherein the percussive impulse device is configured to deliver force impulses with the probe to the portion of the patient body when the probe is applied to the portion of the patient body.

20. The system of claim 19, wherein the percussive impulse device further comprises an armature and an anvil, wherein force impulses are delivered by the armature striking the anvil and delivering a force impulse wave that transmits through the anvil and into the probe.

21. The system of claim 19, wherein the percussive impulse device is configured to analyze the portion of the patient body in contact with the probe.

22. The system of claim 21, wherein the percussive impulse device calculates a test frequency based on the analysis of the portion of the patient body that is in contact with the probe.

23. The system of claim 22, wherein the analysis of the portion of the patient body in contact with the probe is based on time dependent pressure readings detected by the pressure sensor.

24. The system of claim 22, wherein the analysis of the portion of the patient body is based on an initial force impulse to the portion of the patient body and a registered response to the initial force impact through a piezoelectric sensor.

25. The system of claim 21, wherein the test frequency is compared to treatment plan frequencies stored in the system.

26. The system of claim 19, wherein the treatment plan parameters for the first treatment plan comprises a first treatment plan frequency at which to deliver treatment and the second treatment plan comprises a second treatment plan frequency at which to deliver treatment.

27. The system of claim 26, wherein selection of the first treatment plan or the second treatment plan via the GUI signals the percussive impulse device to deliver the force impulses according to the selected first treatment plan frequency or the second treatment plan frequency.

28. The system of claim 27, wherein the first treatment plan frequency is different than the second treatment plan frequency.

29. The system of claim 19, further comprising a pressure wave generator device that is in electrical communication with the at least one processing device,
the memory of the at least one processing device comprising a third treatment plan comprising third treatment plan parameters for delivering pressure waves to the portion of the patient body.

30. The system of claim 29, wherein the third treatment plan parameters comprise a third treatment plan frequency and a third treatment plan pulse rate for the pressure wave generator.

31. The system of claim 19, wherein the percussive impulse device further comprises a microprocessing device comprising:
a second input configured to receive information associated with the therapeutic treatment,
a second output configured to communicate information associated with the therapeutic treatment, and
a second memory in electrical communication with a second CPU, the second memory including treatment plans associated with the therapeutic treatment of the portion of the patient body and algorithms for comparing and selecting treatment plans, the second CPU in electrical communication with the second input and the second output.

32. The system of claim 31, wherein the pressure sensor is in electrical communication with the microprocessor, wherein the pressure sensor is configured to detect applied pressure and communicate time dependent pressure readings to the microprocessor.
